(19) United States
(12) Patent Application Publication
(10) Pub. No.: US 2003/0153237 A1
(43) Pub. Date: Aug. 14, 2003

(54) Expanding shapes and models

(76) Inventor: Amir Genosar, Pardess Chana (IL)

Correspondence Address: MORGAN LEWIS & BOCKIUS LLP, 1111 PENNSYLVANIA AVENUE NW, WASHINGTON, DC, 20004, US

(21) Appl. No.: 10/071,222

(22) Filed: Feb. 11, 2002

(51) Int. Cl. A63H 33/38; B32B 3/26; B32B 3/00

(52) U.S. Cl. 446/150; 428/304.4; 428/314.2; 428/305.5

(57) ABSTRACT

The invention provides an article of manufacture comprising at least three layers, the layers including an inner layer of a compressed expandable material, at least one porous outer layer and at least one outer layer having a surface adapted to receive and retain indicia.

### FIELD OF THE INVENTION

The present invention relates to the fabrication of expanding shapes and models. More specifically, the present invention relates to a raw material and processing method for the production of three-dimensional shapes and models which are produced flat but which then expand on contact with water. This invention also include methods for computerizing the design and manufacturing process of said shapes and models.

### BACKGROUND OF THE INVENTION

Articles such as dolls and soft toys are one of the staples of the toy industry. Although a large range of such products does exist, there is currently no practical means available of inexpensively customizing such products per client, and thus specific development and manufacturing efforts must be made for each separate model. This results in a limitation of different product types, and limitations of inventory can reduce this range still further. Thus there exists a need for an instantly adaptable method of producing customized three-dimensional shapes and model, for soft toys and other applications. The present invention addresses this need from the perspective of production of flat items which expand to their intended three-dimensional shape upon contact with water.

A number of water-expandable products are known in the prior art, typically using a compressed or super-compressed sponge. U.S. Pat. No. 2,952,462 to Planning describes machine collapsed sponges that can be placed in water to form pre-configured 3-dimensional objects. U.S. Pat. No. 4,881,915 to Liaw describes a toy dinosaur egg comprising a cracked shell with a dinosaur model made of compressed sponge inside. On penetration of water via said crack, the sponge dinosaur expands, fully opening the egg. U.S. Pat. No. 5,522,755 to Farell et al describes a plurality of such objects made from super-compressed sponge emerging from a container as they expand. U.S. Pat. No. 5,316,689 to Farell describes such a compressed sponge embedded in a soap such that, after a given amount of use, the surrounding soap dissolves and the enclosed sponge novelty item expands and emerges. U.S. Pat. No. 6,112,380 to Dolan et al describes a novelty shoelace having an aglet comprising a compressed sponge three-dimensional object surrounded by a substantially water impermeable material, where the lace itself serves as a wick which leads the water into the aglet, thus causing it to expand. The use of expanding sponge or foam materials is also known in the medical field, especially in the area of tampons. For example, U.S. Pat. No. 6,183,436 to Korteweg et al describes an absorbent material that is expansible when wetted from a dry stable compressed state to an expanded state.

All these above prior art approaches share the disadvantage that they require specific tooling of manufacturing equipment to fabricate each different shaped item.

It is therefore the object of this invention to provide a manufacturing method allowing for easy and inexpensive customization of three-dimensional models and shapes while using expandable materials such as compressed sponge materials.

It is also the object of the present invention to provide a raw material specifically designed to enable said manufacturing method, said material containing an expandable material that expands on contact with water.

It is furthermore the object of the present invention to provide a computerized method enabling the computerized specification, whether remote or not, of shapes and models to be transmitted to said manufacturing method such that customized designs can be produced on a one-off or multiple basis.

These and other objects of this invention will become more evident in the summary of the invention and in the description of the preferred embodiment.

### SUMMARY OF THE INVENTION

Thus according to the present invention there is now provided an article of manufacture comprising at least three layers, said layers including an inner layer of a compressed expandable material, at least one porous outer layer and at least one outer layer having a surface adapted to receive and retain indicia.

As will be realized the present invention relates to a method for the production of three-dimensional shapes and models using a compressed expandable material.

In preferred embodiments of the present invention said compressed expandable material is a compressed and expandable foam.

In other preferred embodiments of the present invention said article is provided with a fragrance which is released upon expansion of said compressed expandable material.

The present invention also relates to a raw material, to be processed by said method. Said raw material, which can be provided in roll or folded-stack form or in the form of a stack of individual sheets as a stacked material, is composed of a sandwich comprising at least one compressed sponge inner layer (or layers), covered above and below by fabric outer layers, at least one of which is a material which can accept an image; all either glued, sewn or welded together. The sponge center may consist of either a single layer of compressed sponge for a simple model, or a combination of harder and softer sponge for a more contoured effect. The method of production of the finished items is based on (a) applying an image on at least one side (but preferably both sides) of said raw material, (b) sewing, riveting or welding around the intended external outline of desired shape or model, and (c) cutting or scoring around said outline in order to enable the removal of the finished item from the surrounding raw material. Additionally, the sewing, riveting or welding step may be used to limit the expansion of specific portions of the finished item when said item is expanded. On removal of the finished flat item from the manufacturing process from the surrounding (waste) raw material, said item may be mailed or otherwise transported or stored in a space-efficient manner, prior to expansion. On contact with water, the compressed sponge component expands to a three-dimensional shape essentially determined by the sewing and/or riveting of stage (b) above.

The present invention thus also relates to a method of producing a three-dimensional shape or model which remains flat until required and is therefore advantageous in terms of its space requirements. The present invention also provides for the ready customization of the items to be produced, simply by altering the software files describing the shape and printing required.

In this aspect of the present invention there is provided an article of manufacture as described, wherein said article is in the form of a three layered sheet and is provided in combination with machinery and a program for cutting said sheet into any one of a plurality of different predetermined shapes, or supplied on-the-fly by a controlling software program and for interconnecting the periphery of the shaped article cut from said sheet.

Given the simple computerized control of the production process, the present invention furthermore enables a graphic image to be provided by a local or remote computer for printing on the raw material in order to produce a truly one-off or customized model or doll. Furthermore, given that said image may also continue to be stored as a computer image on a local or remote computer, this enables dolls for example to exist in both a real physical implementation (via the manufacturing process) and also in a virtual or screen-based sense.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

The invention is herein described, by way of example only, with reference to the accompanying drawings, wherein:

FIG. 1 illustrates an isometric view of the raw material used for the manufacturing process of the current invention;

FIG. 2 schematically illustrates the manufacturing process for said raw material;

FIG. 3 schematically illustrates the elements of the manufacturing process in which said raw material is processed to produce the flat finished items;

FIG. 4 illustrates a mass-manufacturing version of the manufacturing machinery;

FIG. 5 illustrates a compound product integrating items fabricated according to the process of the present invention;

FIG. 6 illustrates a PC-based implementation of the image definition and production process; and

FIG. 7 illustrates a Web-site based implementation of the image definition and production process.

### DETAILED DESCRIPTION OF THE DRAWINGS

The present invention will be described in detail according to preferred embodiment illustrated in the accompanying drawings. Like reference numerals are used to identify identical components in the various views.

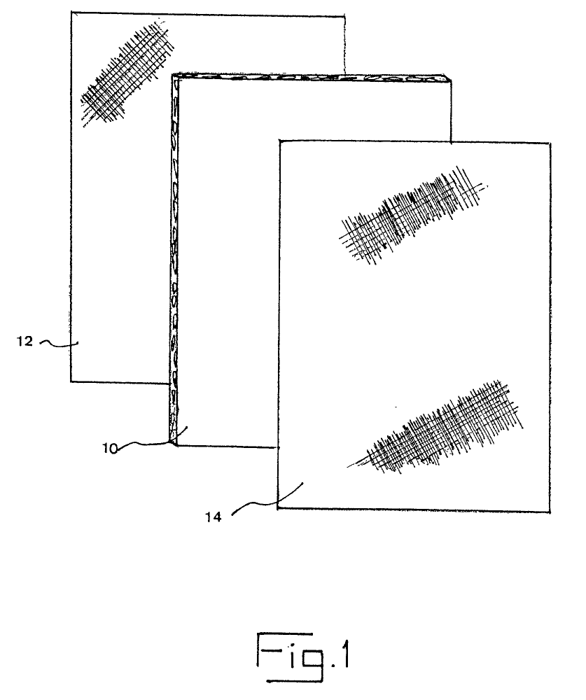

Referring to FIG. 1, the compressed sponge layer 10 is shown in between an upper fabric layer 12 and a lower fabric layer 14. In a preferred embodiment, the compressed sponge 10 is fabricated by taking any kind of compressible sponge, soaking it in polyvinyl alcohol (PVA) and then compressing and drying it. Once dry, the sponge will retain its compressed form due to the PVA acting as a glue. Advantageously, PVA is both water soluble, and non-toxic. The two fabric layers are attached to the compressed sponge layer 10 either by glue or sewing. In a preferred embodiment they are placed either side of the compressed sponge directly after the above compression and drying stage, so that the same step will also glue the fabric layers. The fabric layers may be formed of any natural or synthetic fibers or even a plastic layer may be used. Note however that at least one of the layers must be porous in order that water may penetrate the finished item. In a preferred embodiment, the upper layer 12 is a printable cotton, wool or flax-based fabric. In a further preferred embodiment, the lower layer 14 is also a printable cotton, wool or flax-based fabric. Advantageously, in said preferred embodiments, the finished item will be soft to the touch and have a natural look, appropriate to many types of doll or novelty items.

In a still further embodiment, an additional chemical which responds to the wetting of the finished product may be incorporated either in the glue or attached to one of the layers of the raw material. Where this chemical is baking soda, a gas will be given off as the product expands when soaked in water, making the expansion process more exciting. Where this chemical is an odor or a perfume, a pleasant odor that will accompany the product appears as the product expands.

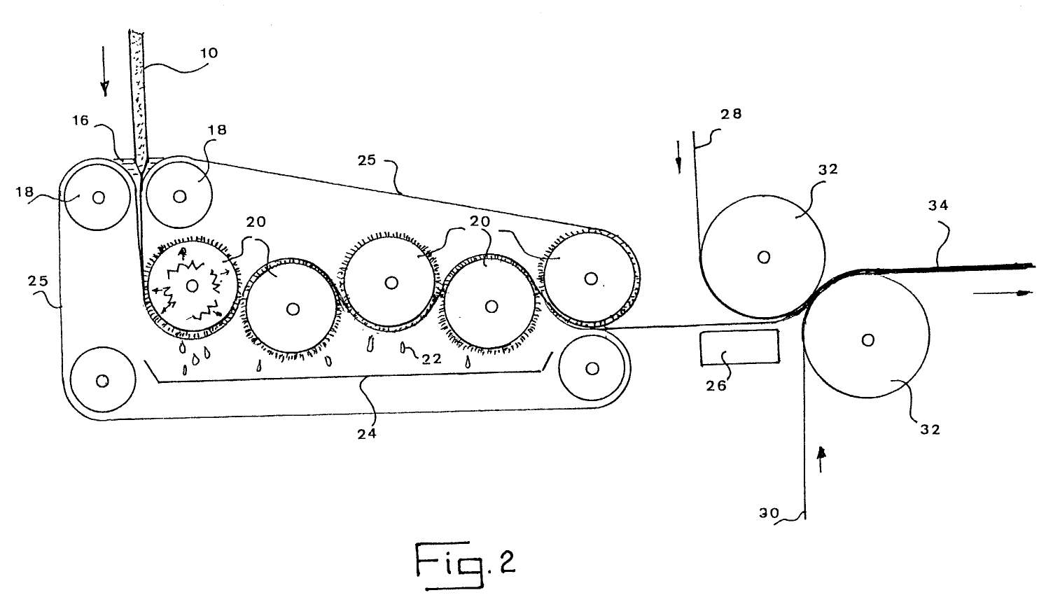

Referring now to FIG. 2, a preferred embodiment of the process of producing the raw material of the present invention is shown in detail. The sponge 10 is soaked with liquid adhesive 16 as it flows between two rollers 18 in order to compress a now wet sponge. Said wet sponge then proceeds through a multi-drum track 20 which heats and dries the compressed sponge, where the excess adhesive 22 is collected in a tray 24 for recycling. The present embodiment shows upper and lower steel endless perforated belts 25 confining the wet sponge. The substantially dry compressed sponge is then preconditioned for fabric addition by a pre-conditioning unit 26 and then fabric layers from above 28 and below 30 are merged to produce the raw material 34 of the present invention. In a preferred embodiment, the pre-conditioning unit 26 will slightly wet the compressed sponge, such that the adhesive embedded therein will serve to adhere the fabric 28, on passing through the rollers 32. On emerging from rollers 32, the finished raw material 34 will preferably be either collected on a roll or stacked.

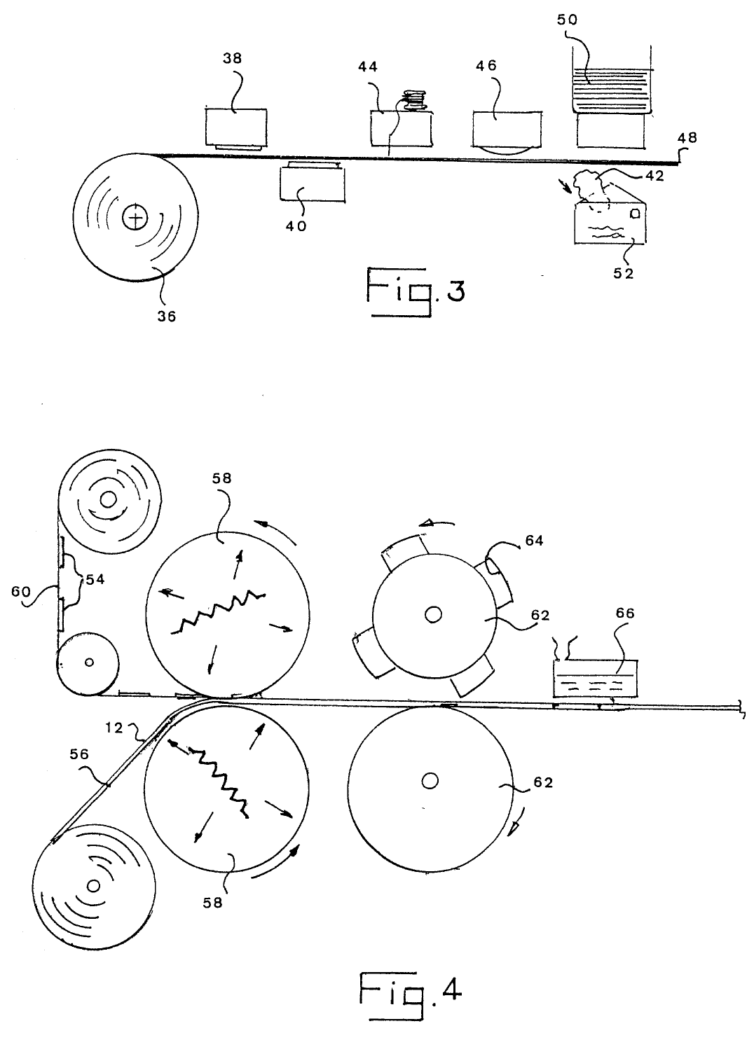

Referring now to FIG. 3, the elements of a low-volume manufacturing process in which said raw material is processed to produce the flat finished items are shown. Said process uses an input roll 36 which is fed directly between an upper printing head 38 (and optionally also a lower printing head 40) in order to impart the graphic image that will appear on the finished items 42. After the printing, a sewing head 44 fixes the outline of said items and then a cutting unit 46 cuts or scores around said outline so that the finished items 42 can be removed from the surrounding raw material 48. In a preferred embodiment for automatic remote operation, a packaging unit 50 places the finished item 42 in an envelope 52 for mailing. Where the finished item is being handed over directly to the customer (such as at a fast-food restaurant), the raw material “page” containing the item can be given directly to the customer, and thus the need for packaging is obviated. Thus a range of novel products are enabled, where the finished items manufactured according to the process of the present invention constitute a component of said novel products.

Referring now to FIG. 4, a high-volume manufacturing process for producing finished items from the raw material is shown schematically. In order to achieve a rapid throughput, the printing of the images for transferring to the raw material is performed on stickers 54 (also known as “transfers”) in advance. Then the process consists firstly of passing the raw material 56 and the stickers 54 between two hot drums 58. The passage between the hot drums 58 causes the image to be transferred from the backing layer 60 of the sticker to the fabric layer 12 of the raw material. The thus printed raw material then passes between two further drums 62 which carry multiple cutting edges to form the cutting pattern 64. The individual items then have their edges coated with a non water-soluble glue by an applicator unit 66, and this ensures that the edges of the finished items do not open up, thereby replacing the sewing function in the lower volume manufacturing process as per FIG. 3. In this manner, a very rapid production of novelty items can be effected. Typical applications include the production of small models or dolls for insertion into snack food packages, cereal boxes, etc.

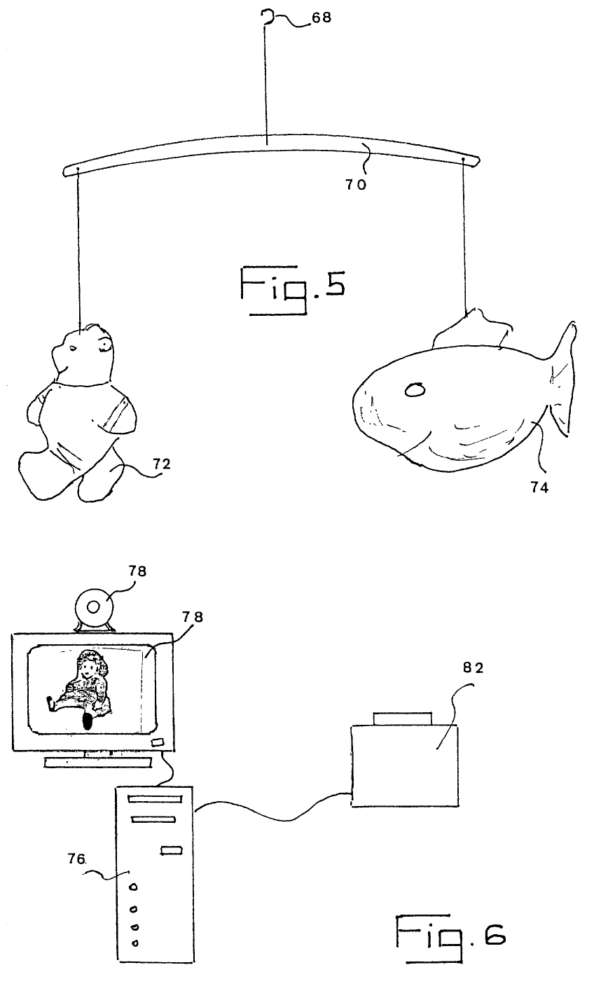

Referring now to FIG. 5, a typical product containing finished items as per the production process of the present invention is shown. In this preferred embodiment, the product is a mobile for hanging in a child's room. It comprises a hook 68 for attachment to the ceiling, a spacing bar 70 for separating the different hanging items, and two or more expandable items 72 and 74 produced according to the present invention. Advantageously, said product can be packaged in a flat envelope for mailing or sale, and can then be expanded to a full three-dimensional product by placing the expandable items 72 and 74 in contact with water.

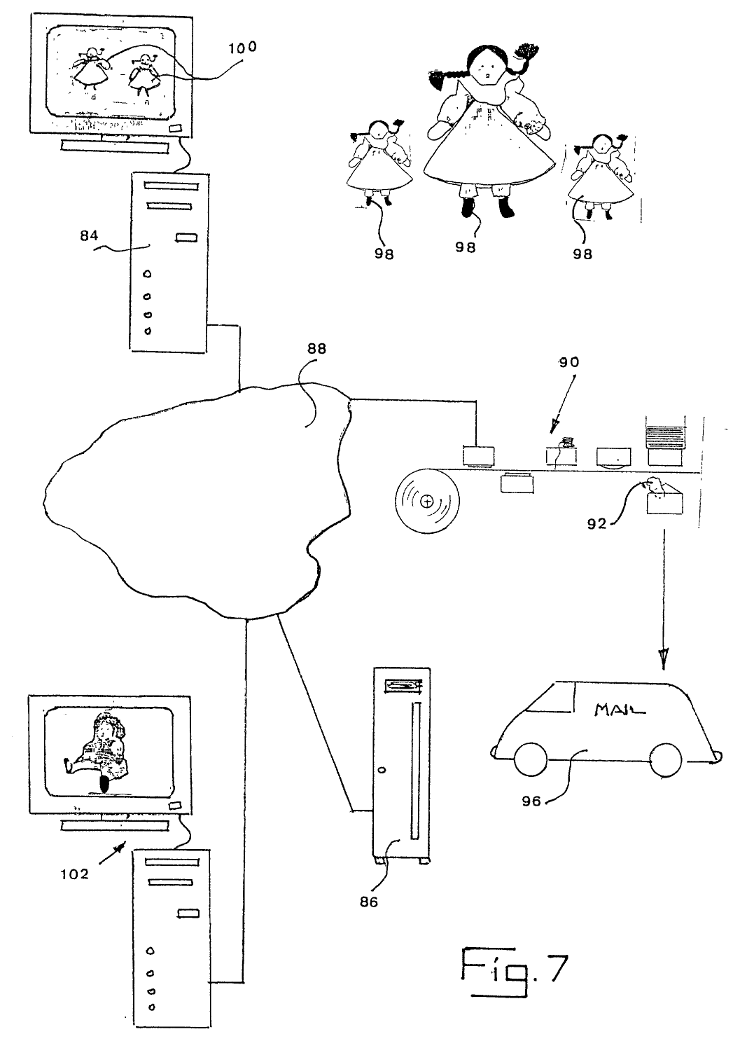

Referring now to FIG. 6, the implementation of the current invention as a PC based system is shown. In this embodiment, the image required is either chosen from a PC or other local computer 76, where a selection may be made from the screen 78 or alternatively a camera 80 may be used to digitize the image of a subject in order to, for example, produce a doll or bust of said subject. In a further enhancement, the image specified may be a combination of say, a face digitized via the camera 80 and body parts or clothes selected from items displayed on the screen 78. This implementation is advantageous for, for example, fast food restaurants wishing to enable clients to choose from a large range of dolls, but not wishing to maintain a large inventory of said dolls. In this case, the customers simply chooses the wanted doll from the selection displayed on the screen 78. The implementation involving the merging of an image from the camera 80 is advantageous for photo kiosks and such like, enabling them to offer something akin to a passport photo but as a three-dimensional object. In all of the above cases, the resulting software instructions are sent to the production machine 82 (as described in FIG. 4 above) and the one-off flat product produced. This product is given to the client in its flat form and may be extracted and expanded by exposure to water at home.

Referring now to FIG. 7, a Web-site implementation of the model specification and production process is shown. In this embodiment, a child chooses or designs his or her own dolls using a browser on a PC 84, where the server 86 of a Web site 88 controls a mass production version of the manufacturing process (as detailed in FIG. 3). In this way, the child orders dolls that are extracted from the output 92 of the machine 90, and arrive by mail 96. Advantageously, the design of each such doll is also maintained on the Web site associated with that child's ID, in order that dolls may be viewed both in reality 98 and in their virtual form 100. Given that a large number of additional users 102 may use the Web site, this enables the creation of a virtual community of children, together with their dolls, enabling a meaningful interaction between such children via the Web site 88.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An article of manufacture comprising at least three layers, said layers including an inner layer of a compressed expandable material, at least one porous outer layer and at least one outer layer having a surface adapted to receive and retain indicia.

2. An article of manufacture according to claim 1, wherein said compressed expandable material is adapted to expand in the presence of aqueous medium.

3. An article of manufacture according to claim 1, wherein said article is a sponge toy.

4. An article of manufacture according to claim 1, wherein said article of manufacture is a greeting card.

5. An article of manufacture according to claim 1, wherein at least one of the outer layers is provided with an image, said article is substantially flat and is adapted to expand into a three dimensional article of greater bulk than the original article of manufacture when exposed to an aqueous medium.

6. An article of manufacture according to claim 1, wherein said article is in the form of a three layered sheet and is provided in combination with machinery and a program for cutting said sheet into any one of a plurality of different predetermined shapes and for interconnecting the periphery of the shaped article cut from said sheet.

7. An article of manufacture according to claim 1 wherein said indicia includes a picture.

8. An article of manufacture according to claim 1 wherein said indicia includes textual material.

9. An article of manufacture according to claim 1 wherein said compressed expandable material is a compressed and expandable foam.

10. An article of manufacture according to claim 1 wherein said article is provided with a fragrance which is released upon expansion of said compressed expandable material.
